(19) United States
(12) Patent Application Publication
(10) Pub. No.: US 2012/0095797 A1
(43) Pub. Date: Apr. 19, 2012

(54) Method of Managing Access Right, and System and Computer Program for the Same

(75) Inventors: Yasutaka Nishimura, Yamato (JP); Akira Ohkado, Yamato (JP); Tadashi Tsumura, Yamato (JP)

(73) Assignee: INTERNATIONAL BUSINESS MACHINES CORPORATION, Armonk, NY (US)

(21) Appl. No.: 13/246,044

(22) Filed: Sep. 27, 2011

(30) Foreign Application Priority Data
Sep. 30, 2010 (JP) 2010-222313

(51) Int. Cl. G06Q 10/06; G06F 21/00

(52) U.S. Cl. 705/7.13; 726/17; 726/20

(57) ABSTRACT

A method of managing an access right to at least one asset associated with at least one digital work order, to at least one first element associated with the at least one asset, or to at least one second element associated with an access path to the at least one asset or the first element, and relates to a system and a computer program for the same.

### BACKGROUND

1. Field

The present invention relates to a method of managing an access right, and to a system and a computer program for the same. More specifically, the present invention relates to a method of managing an access right to at least one asset associated with at least one digital work order, to at least one element (called a first element hereinafter) associated with the asset, or to at least one element (called a second element hereinafter) associated with an access path to the asset or the first element, and also relates to a system and a computer program for the same.

2. Description of the Related Art

Assets (e.g., a computer, a computer peripheral device, a lighting device, an air conditioner, and a power generator) are managed and maintained on the basis of a work process. A work order is issued based on this work process. Specific works for the management and maintenance are performed on the basis of this work order. The work order is automatically created so that the assets can be managed and maintained at a desired schedule (e.g., every month or every two months) or according to the frequency of use (e.g., every 300 operation hours), or is created by an asset manager when necessary. When the work order is approved through a predetermined process, the work described in the work order becomes an executable work. The executable work is assigned to a worker in consideration of, for example: a date on which the work should be executed; a qualification, a skill, and years of experience of the worker to execute the work; and an amount of work already assigned to the worker. The worker checks the assigned work and registers the start and the completion of the work in a predetermined asset management application, or reports them to an asset manager.

Each asset is managed and maintained in accordance with the standardized procedure in the work order. Even in an emergent case, the asset is maintained by issuing a work order for an emergent maintenance. In addition, work orders can be issued such that the completion of work for the current work order may trigger start of work for the next work order.

Asset management and maintenance are implemented by use of International Business Machines Corporation (registered trademark) (hereinafter, referred to as IBM (registered trademark)) Maximo (registered trademark) Asset Management (hereinafter referred to as Maximo (registered trademark)) sold by IBM (registered trademark). One of functions of Maximo (registered trademark) is asset management.

Japanese Patent Application Publication No. 2008-276511 listed below describes a method and an apparatus that enable providing an action center for execution of work (paragraph [0008]). The action center is generated as a modeled software application that provides dynamic access to data and one or more callable services for performing an activity related to the data. The dynamic access is provided based on an authorization for the access determined based on a work role associated with a request for the related data. The request for the data is related to a work activity in a workflow associated with the data.

Japanese Patent Application Publication No. 2002-63323 listed below describes a system for supporting activities in an operation process by providing a terminal device used in each of the activities with an access service to an operation database used for the activity (claim 24). The system includes: a service definition table in which an access service is defined for each service target that is an activity or a unit activity in a service process; an identification unit that identifies a service target on the basis of a service request issued by a terminal device; and a service provision unit that provides an access service to an operation database for the terminal device that has issued the service request in accordance with the definition of the access service for the identified service target in the service definition table.

In a physical access control, an access controller manages one or multiple access management targets (e.g., a door a). The physical access control is performed in units of users or in units of ID cards owned by the respective users. For example, the access controller allows users A and B to access the door a, but does not allow a user C to access the door a. In addition, for example, the access controller allows a card ID A012345 to access the door a but does not allow a card ID B012345 to access the door a.

In a role-based access control, an access controller defines a role representing a function in work and gives the role a right to execute a certain operation. Thus, the access controller does not give a user the right directly, but gives the user the right through the role. Hence, the access controller can easily perform access control by adding or deleting a user to or from the role.

However, none of the foregoing access controls is associated with a work process. An object of the present invention is to give a worker associated with a work order an access right to an asset while the worker is performing management and maintenance work in accordance with the work order.

### SUMMARY

The present invention provides a method of managing an access right to at least one asset associated with at least one digital work order, to at least one element (also called a first element hereinafter) associated with the asset, or to at least one element (also called a second element hereinafter) associated with an access path to the asset or the first element. The method is executed by processing by a computer. The method includes the steps of: at a scheduled start time for a work order to be executed, or in response to reception of a report indicating the start of work for the work order to be executed or a report indicating the completion of work for a preceding work order to the work order to be executed, loading the work order to be executed into a memory, and authorizing a worker entity, designated in the loaded work order to be executed, to have an access right to the asset, the first element or the second element associated with the work order to be executed; and revoking the granting of the access right at a scheduled completion time for a work order already started, or in response to reception of a report indicating the completion of work for the work order already started or a report indicating the start of work for a succeeding work order to the work order already started. The access right may be granted by associating the worker entity to the work order to be executed.

Furthermore, the present invention provides a computer program for managing the access right to the asset, the first element, or the second element. The computer program causes a computer to execute the steps in the method.

Furthermore, the present invention provides a system for managing the access right to the asset, the first element, or the second element. The system includes: an authorization unit that, at a scheduled start time for a work order to be executed, or in response to reception of a report indicating the start of work for the work order to be executed or a report indicating the completion of work for a preceding work order to the work order to be executed, loads the work order to be executed into a memory, and authorizes a worker entity, designated in the loaded work order to be executed, to have an access right to the asset, the first element or the second element associated with the work order to be executed; and revocation unit that revokes the granting of the access right at a scheduled completion time for a work order already started, or in response to reception of a report indicating the completion of work for the work order already started or a report indicating the start of work for a succeeding work order to the work order already started.

In one embodiment of the present invention, the system includes: an access token generation unit that generates an access token in association with the work order to be executed, the access token being used for the granting of the access right to the asset, the first element, or the second element; and a transmitter that transmits the generated access token to a security device carried by the worker entity authorized to have the access right, the transmitted token being written to the security device. When the access token is transmitted to the security device, the token is written in, for example, a memory in the security device.

In one embodiment of the present invention, the system further includes an access token deletion unit that deletes or invalidate an access token in the security device, the access token associated with the work order scheduled to be completed or the completed work order, at the scheduled completion time for the work order already started, or in response to reception of the report indicating the completion of work for the work order already started or the report indicating the start of work for the succeeding work order to the work order already started.

### BRIEF DESCRIPTION OF THE SEVERAL VIEWS OF THE DRAWINGS

FIG. 1 is a basic block diagram of computer hardware in an embodiment of the present invention.

FIG. 2 is a functional block diagram of a system according to the embodiment of the present invention that has a function of the computer hardware shown in FIG. 1.

FIG. 3 is a functional block diagram of the system shown in FIG. 2.

FIG. 4 is a block diagram of the system shown in FIG. 2, in a case where the system includes a configuration management system and a configuration management database.

FIG. 5 shows a data model, a CI instance, discovery information, and a relation model used in the system in FIG. 4.

FIG. 6 shows management subjects of the systems shown in FIGS. 2 to 4.

FIG. 7 shows processes performed by using the system shown in FIG. 2 for access right management of the embodiment of the present invention.

### DETAILED DESCRIPTION

An embodiment of the present invention is described below with reference to the drawings. In the drawings, the same reference numerals denote the same components unless otherwise specified. It should be understood that the embodiment of the present invention is given for describing a preferable embodiment of the present invention and does not intend to limit the scope of the present invention to what is described herein.

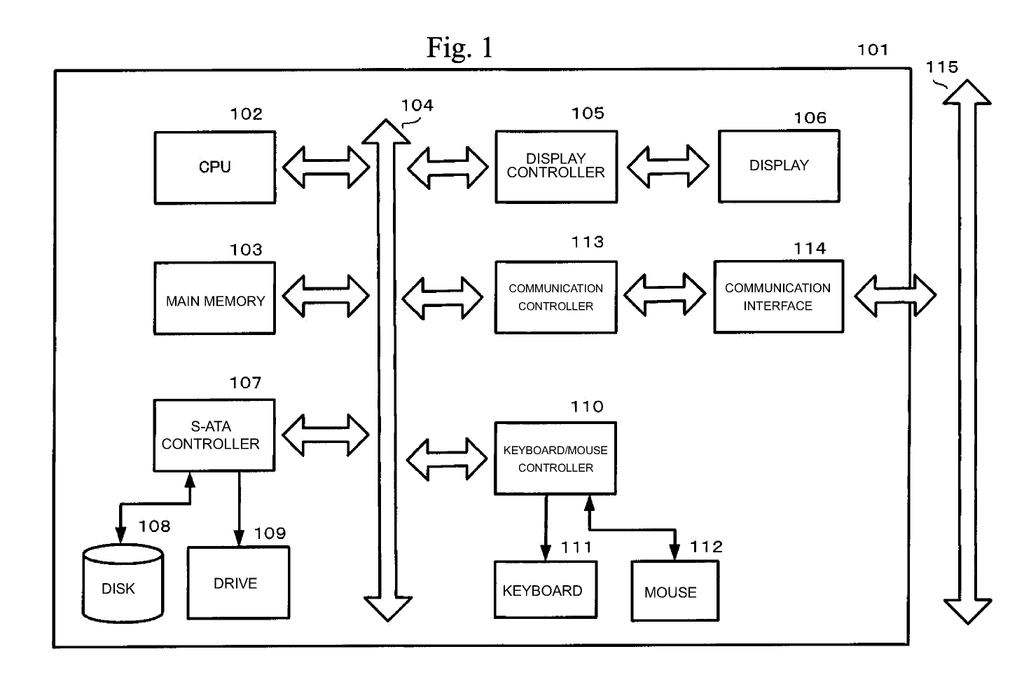

FIG. 1 is a basic block diagram of computer hardware in an embodiment of the present invention.

A computer (101) includes a CPU (102) and a main memory (103) that are connected to a bus (104). The CPU (102) is preferably based on a 32-bit or 64-bit architecture and, for example, the following may be used as the CPU (102): Intel's Core i (trademark) series, Core 2 (trademark) series, Atom (trademark) series, Xeon (registered trademark) series, Pentium (registered trademark) series, and Celeron (registered trademark) series; and AMD's Phenom (trademark) series, Athlon (trademark) series, Turion (trademark) series, and Sempron (trademark) series. A display (106), e.g., a liquid crystal display (LCD), may be connected to the bus (104) via a display controller (105). The display (106) is used to display information on a computer connected to a network through a communication line and software running on the computer with an appropriate graphic interface, for the management of the computer. A disk (108), e.g., a hard disk or a silicon disk, as well as a drive (109), e.g., a CD drive, a DVD drive, or a BD drive may also be connected to the bus (104) via a SATA/IDE controller (107). Furthermore, a keyboard (111) and a mouse (112) may be connected to the bus (104) via a keyboard/mouse controller (110) or a USB bus (not illustrated).

The disk (108) stores an operating system, a program for providing Java (registered trademark) processing environment such as J2EE, a Java (registered trademark) application, and a Java (registered trademark) virtual machine (VM), a Java (registered trademark) JIT compiler, other programs, and data, so as to be loadable onto the main memory (103). The drive (109) is used to install a program from a CD-ROM, a DVD-ROM, or a BD to the disk (108) as required.

A communication interface (114) conforms to an Ethernet (registered trademark) protocol, for example. The communication interface (114) is connected to the bus (104) via a communication controller (113) and plays a role of physically connecting the computer (101) to a communication line (115). Thus, the communication interface (114) provides a network interface layer for a TCP/IP communication protocol of a communication function of the operating system of the computer (101). The communication line may be a wired LAN environment or a wireless LAN environment based on a wireless LAN connection standard such as IEEE802.11a/b/g/n, for example.

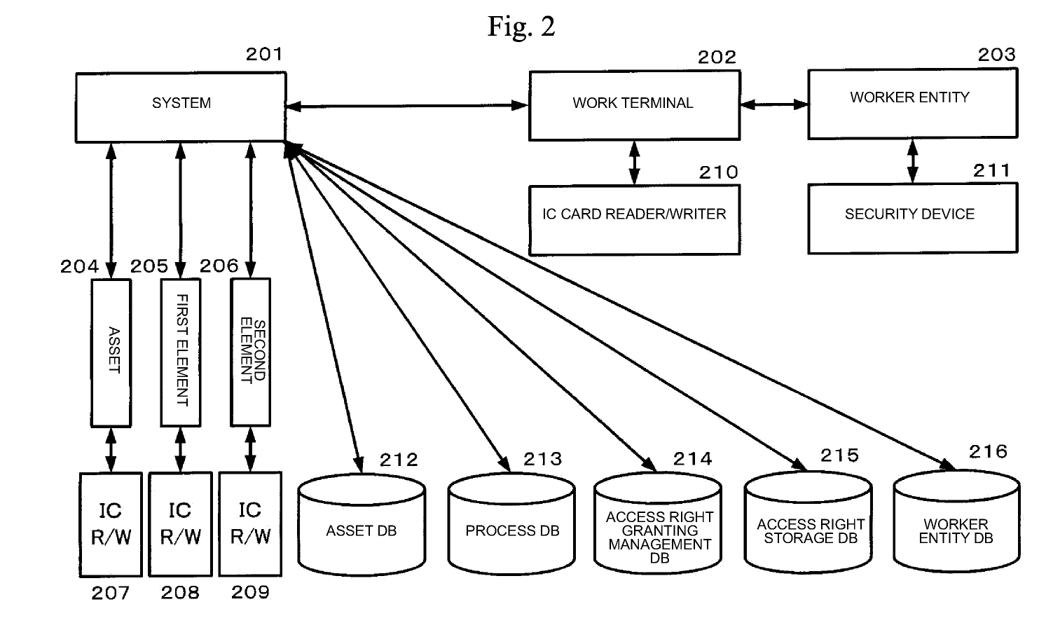

FIG. 2 is a functional block diagram of a system (201) according to the embodiment of the present invention that has a function of the computer hardware (101) shown in FIG. 1.

The system (201) may be connected to a work terminal (202) (serving as a user terminal for a worker entity (203)) that may access the system through a wired or wireless network. The network may be either the Internet or a private network. Work-assigned entities (203) can access the system (201) through the work terminal (202).

In view of the asset and work management, the system (201) may be configured as a single asset management system, such as Maximo (registered trademark), which manages assets while managing the work for maintaining the assets. Alternatively, the system (201) may be configured of at least two individual systems (not illustrated) consisting of a system for managing assets and a system for managing a work for maintaining the assets.

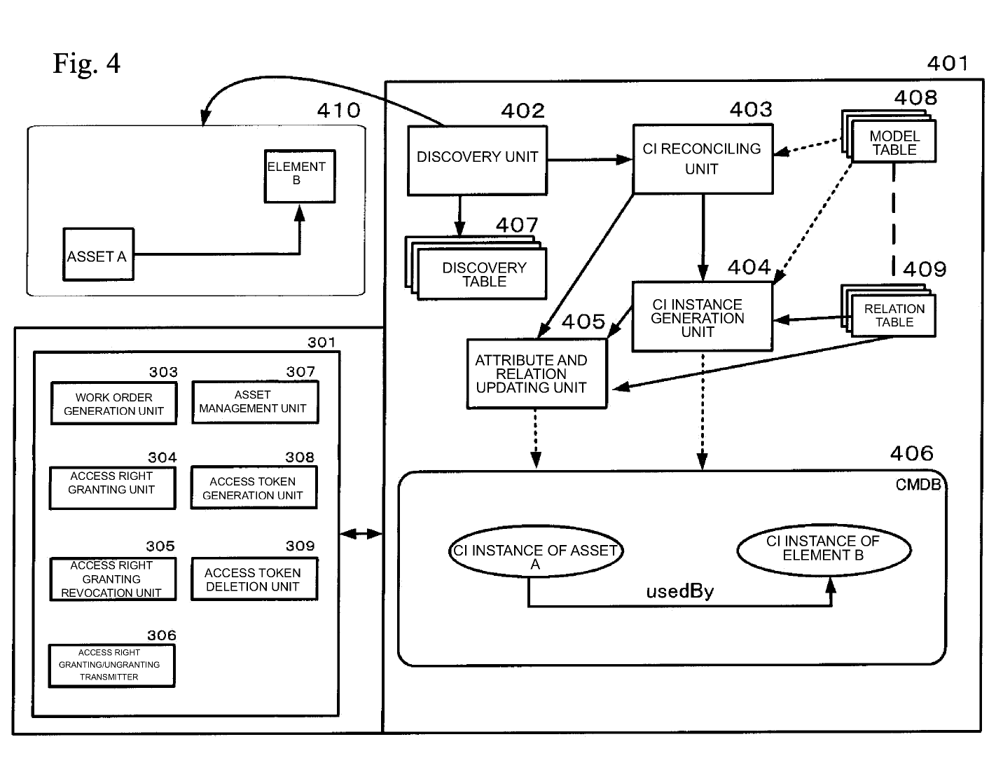

Furthermore, the system (201) may be a system including: a configuration management system having the function of the asset management system; and a configuration management database (CMDB) (see, FIG. 4 below). The CMDB may be provided in the configuration management system or may be connected to the configuration management system through the network (hereinafter, the term “configuration management system” includes the CMDB). The configuration management system may be connected to the asset management system instead of having the function of the system mentioned above. The system (201) as the configuration management system may manage an asset, a first element, and/or a second element as a configuration item which may be stored in the CMDB.

The system (201) may manage assets (204), first elements (205), and/or second elements (206) using, for example, an asset management database (212) or a CMDB (406).

The assets (204) are tangible objects and are so-called hardware resources. The assets (204) may be managed by the system (201) such as Maximo (registered trademark), for example. It is impossible to list all the assets (204). For example, the assets (204) include: vehicles such as an airplane, a train, and an automobile; industrial equipment such as a generator, a water purifier, a pump, and a robot; and IT equipment such as a server, a computer, and a printer. Each of the assets (204) as a hardware resource connectable to the network may be connected to the system (201) through the network. The asset (204) does not necessarily have to be connected to the system (201). For example, the asset (204) may be connected to the system (201) through a computer (not illustrated) associated with the asset (204). The asset (204) may be accessible by a security device (211) associated with a corresponding one of the work-assigned entities (203).

The asset (204) may be associated with a corresponding one of the first elements (205) and/or a corresponding one of the second elements (206).

In the embodiment of the present invention, the first element (205) is a material or a tool associated with the asset (204), or a material or a tool for managing and maintaining the asset (204). For example, in Maximo (registered trademark), an expendable object is referred to as the material and an object that can be repeatedly used is referred to as the tool. When being connectable to the network, the first element (205) may be connected to the system (201) through the network. The first element (205) does not necessarily have to be connected to the system (201) and may be connected to the system (201) through a computer (not illustrated) associated with the first element (205). The first element (205) may be accessible by the security device (211) associated with the worker entity (203).

The first element (205) may be associated with the at least one element (second element) (206) associated with an access path to the first element (205).

In the embodiment of the present invention, the at least one element (second element) (206) associated with the access path to the asset (204) or the first element (205) is, for example, an entrance/exit mechanism provided on a path (route) through which the asset (204) or the first element (205) is accessed. The entrance/exit mechanism is, for example, a doorway to a room in which the asset (204) or the first element (205) is stored or placed, a doorway to a floor on which the room is present, a doorway to a building including the floor, or a doorway to a site including the building. When being connectable to the network, the second element (206) may be connected to the system (201) through the network. The second element (206) may be unlockable by the security device (211) associated with the worker entity (203).

In the embodiment of the present invention, the worker entity (203) may be a person or a robot that performs the work on the basis of a work order. The worker entity (203) is also called a labor in Maximo (registered trademark). The person may be a work manager, for example. The robot may be an autonomously operating robot, for example. When the robot does not operate autonomously, the security in the route through which the order is given to the robot should be secured so that the robot only performs the explicitly ordered work. When the security in the route through which the order is given to the robot is secured, the assignment of the work may substantially be accompanied with the granting of the access right. The worker entity (203) is associated with, for example, information (hereinafter, also referred to as information associated with an worker entity (203)) such as a work entity ID, a department name or a company name, an employee type, a qualification, a skill, an experience, and a work assignment status.

The worker entity (203) may carry the security device (211) around with himself/herself, the security device (211) including, for example, an IC card (may be of contact type or non-contact type), a memory device (e.g., a USB memory), a cell phone, a personal digital assistant (PDA), a watch type security device, and a bracelet type security device. The security device (211) may include a memory for storing therein an access token used for granting the access right to the asset (204), the first element (205), or the second element (206).

When the security device (211) is an IC card or a memory device, the system (201) can add or delete an access token to or from the IC card or the memory device by using a reader/writer (210) (hereinafter, referred to as reader/writer) for the IC card or the memory device. Thus, it is not indispensable that the IC card itself and the memory device be communicable with the work terminal (202) in such a case. When the security device (211) is a cell phone or a PDA, for example, the cell phone or the PDA may be communicable with the work terminal (202) through wireless communication, e.g., communication using Bluetooth and WiFi, for example.

When a central server sets the access rights, the cell phone or the PDA may be used only for the authentication for the work terminal (202), the asset (204), the first element (205), or the second element (206) and no update is made to the security device (211).

The security device (211) may be used for the authentication for the worker entity (203) to access the asset (204) or the first element (205). The security device (211) may be used for the authentication for the worker entity (203) to access the second element (206) (mainly entering). Specifically, the security device (211) may be used for unlocking the door for entrance or exit of the worker entity (203). The security device (211) may be set so that the door can be unlocked, on condition that the access token is stored therein. The security device (211) may be used as a user authentication device for the worker entity (203) to log into the system (201) through the work terminal (202). Thus, the worker entity (203) may use the security device (211) to access the asset (204), the first element (205), and/or the second element (206), and/or for user authentication by the system (201).

The security device (211) may also be used for reporting the start or completion of work for a work order. The reporting may be done by the worker entity (203) through logging into the system (201) from the work terminal (202) by use of the security device (211) and through selecting the started or completed work by use of a mouse and the like.

The asset (204) may be associated with a reader/writer (207) for reading the security device (211) and writing data, e.g., a token, to the security device (211). The writer function is optional. The reader/writer (207) may be provided to the asset (204) or may be provided in a shelf or the like in which the asset (204) is provided or stored.

The first element (205) may be associated with a reader/writer (208). The reader/writer (208) may or may not have a writer function. The reader/writer (208) may be provided to the first element (205) or provided in a shelf or the like in which the first element (205) is stored.

The second element (206) may be associated with a reader/writer (209). The writer function may or may not be provided. The reader/writer (209) may be placed on the second element (206) or placed on a wall or the like near a location in which the second element (206) is installed.

The work terminal (202) may be associated with a reader/writer (210). The writer function may or may not be provided. The reader/writer (210) may be provided to the work terminal (202) or provided on a desk or the like in which the work terminal (202) is provided.

The system (201) may be connected through the network or directly by a cable to various databases. The various databases may include an asset database (212), a process database (213), an access right granting management database (214), an access right storage database (215), and a worker entity database (216).

The asset database (212) may be connected to the system (201) through the network, for example. The asset database (212) may store therein information on asset, information on first element, information on second element, information on association between asset and first element, information on association between asset and second element, and/or information on association between first element and second element.

The information on asset is, for example, a location of each asset (e.g., a room, a floor, a building, an address, a zip-code, and a country). The information on asset may also be a name, a serial number, a managing department, a manager, a seller, a manufacturer, an installation date, a quantity, a purchase or unit price, an updating cost, and/or a scheduled depreciation date.

The information on first element may be such information as a name, a serial number, a storage place (a room number, a floor, a building, an address, a zip-code, and a country), a managing department, a manager, a seller, a manufacturer, an installation date, a stock (quantity), a purchase or unit price, and/or an expiration date of use, for example.

The information on second element may be such information as a name, a serial number, a storage place (a room number, a floor, a building, an address, a zip-code, and a country), a managing department, a manager, a seller, a manufacturer, an installation date, a stock (quantity), a purchase or unit price, and/or an expiration date of use, for example.

The information on association between asset and first element is, for example, information in which the first element required for maintaining the asset is associated with the asset.

The information on association between asset and second element is, for example, information in which the second element required for an access path to the asset is associated with the asset.

The information on association between first element and second element is, for example, information in which the first element is associated with the second element required for an access path to the first element.

The process database (213) may be connected to the system (201) through the network, for example. The process database (213) may store therein a work process and/or a work order issued on the basis of the work process.

In the embodiment of the present invention, the work process is a predetermined work procedure for business. The work process may or may not comply with IT Infrastructure Library (hereinafter, referred to as ITIL). For example, the work process does not generally comply with ITIL in an asset management for a generator, pump, or the like. The work process may comply with ITIL when the system (201) includes the configuration management system and the configuration management database (CMDB). When the system (201) is the configuration management system, the work process includes a work for incident management. The incident is roughly divided into a service request and a failure.

The service request is a general and simple request. Various service requests are conceivable in various industries. For example, in the IT industry the service request includes forgetting a service user ID for using an IT infrastructure, shortage of supplies such as toner or paper in a printer, and an inquiry on how to operate an application.

The failure is a trouble state in general. Various failures are conceivable in various industries. For example, the failure in the IT industry includes a failure of the IT infrastructure, a malfunction of an application, virus infection, and a state in which the use of IT service is hindered because the IT service is not the one desired for the business service.

The work process includes a business process. The business process may be defined as a flow for achieving a certain goal, including tasks and attributes (a person, a tool, a material, a cost, a service, and the like) for performing the tasks. For example, the business process includes the following flow: (1) a work manager approves a work process; (2) a worker entity (203) executes one or more tasks in the approved work process; (3) the worker entity (203) reports the completion of the task; and (4) the work manager audits the completed task.

Specific examples of the work process are listed below. The present invention is not limited thereto and may include any work process for business.

1. Work Process for Service Request (System Maintenance)

(1) A backup system performs weekly backup to a tape every Sunday.

(2) A person in charge of the backup collects the tape on Monday morning.

(3) The person in charge of the backup sets a next backup tape in the backup system.

(4) The backup system and/or the room including the backup system (i.e., entrance/exit door) cannot be accessed at any time except for the time for the above processing.

2. Work Process for Business Process (Security)

(1) An employee of a security company loads a container on a transportation vehicle for transporting valuable goods (cash, precious metals, a stock certificate, and the like).

(2) The employee of the security company sends the transportation vehicle to a destination for receiving the valuable goods.

(3) When the employee of the security company arrives at the destination, a person in charge of managing the valuable goods opens a door on an entrance path to a safe.

(4) The employee of the security company puts the valuable goods in the container.

(5) The person in charge of managing the valuable goods closes the door to the safe.

(6) The employee of the security company loads the container on the transportation vehicle.

(7) The employee of the security company transports the container to a destination.

3. Work Process for Service Request (Safety)

(1) An operator stops incinerator operation.

(2) After the operation is stopped, a security staff checks that the temperature in the incinerator is not higher than a predetermined value and the oxygen level in the incinerator is not lower than a predetermined value.

(3) After the checking, a cleaning staff starts cleaning the incinerator.

(4) The operator restarts the incinerator operation.

4. Work Process for Failure (RAID Failure)

(1) A RAID management system notifies a manager of an occurrence of a failure in RAID hard disks.

(2) The manager replaces a hard disk in which the failure occurs.

(3) The manager backs up data in the RAID hard disks in external hard disks as required.

5. Work Process for Failure (Virus Infection)

(1) A virus detection system notifies a system administrator of virus invasion.

(2) The system administrator isolates the personal computer infected with the virus from a network.

(3) The system administrator gets rid of the virus or erases the content of the hard disk and replaces the contents with backup data.

The work order may be in a digital format, stored in a disk (108) and loaded into the memory (103). The work order may be a single work order. Alternatively, a single work order may include a single or multiple other work orders depending on a scale of the work. Furthermore, the included work order may further include a single or multiple work orders. Thus, a single work order may have a structure that may include one or multiple work orders in a hierarchical manner. Generally, when a work order includes multiple work orders, the sequence of the work orders is specified. The sequence may be either (1) a sequence which is a procedure in which the work is done, or (2) a sequence which is a predetermined order in performing works stipulated in the work process and thus observation of which is required. (1) The sequence which is a procedure in which the work is done is a kind of procedure such as removing a cover and then accessing a device inside. Thus, in this example, the work cannot be done without observing the procedure. In contrast, (2) the sequence which is the predetermined order in performing works stipulated in the work process and thus compliance of which is required is exemplified in the following case. While cleaning an incinerator (described in B below), a cleaning staff can start cleaning the incinerator without a safety staff checking the oxygen level, the work process indispensably requires the sequence to be observed for the safety of the cleaning staff.

A minimum unit of a work order may be referred to as a task. Since the task is a type of the work order, the “task” is not excluded when the term “work order” is referred to in the embodiment of the present invention.

The work order may include information on: an asset to be worked on; a first element required for the work on the asset; the number of work-assigned entities; a scheduled work start date and a scheduled work completion date, or a work period; and a work manager.

The work order may be issued by the system (201) on the basis of the work process. In case the system (201) is the configuration management system, the system may issue the work order on the basis of a change management process used in the configuration management system. Alternatively, the work order may be issued on the basis of a release management process that releases the change approved by the change management process in ITIL version 2 (ITIL V2).

The work order is associated with information such as the asset as a work subject, hierarchical information on the work order, an order of the work order in the sequence, target dates and times of work start and completion, a work location, a work ordering department, a work managing department, and an account code.

The access right granting management database (214) may be connected to the system (201) through the network, for example. The access right granting management database (214) stores therein information for managing whether the worker entity (203) is authorized to access the asset (204), the first element (205), or the second element (206).

The access right storage database (215) may be connected to the system (201) through the network, for example. The access right storage database (215) stores therein information for managing the asset (204) associated with the work order, the first element (205), or the second element (206).

The worker entity database (216) may be connected to the system (201) through the network, for example. The worker entity database (216) stores therein information on a schedule, an already assigned work amount, and a transfer route of the worker entity (203), as well as a information on the worker entity, for example, qualification, a skill, and years of experience of the worker entity (203).

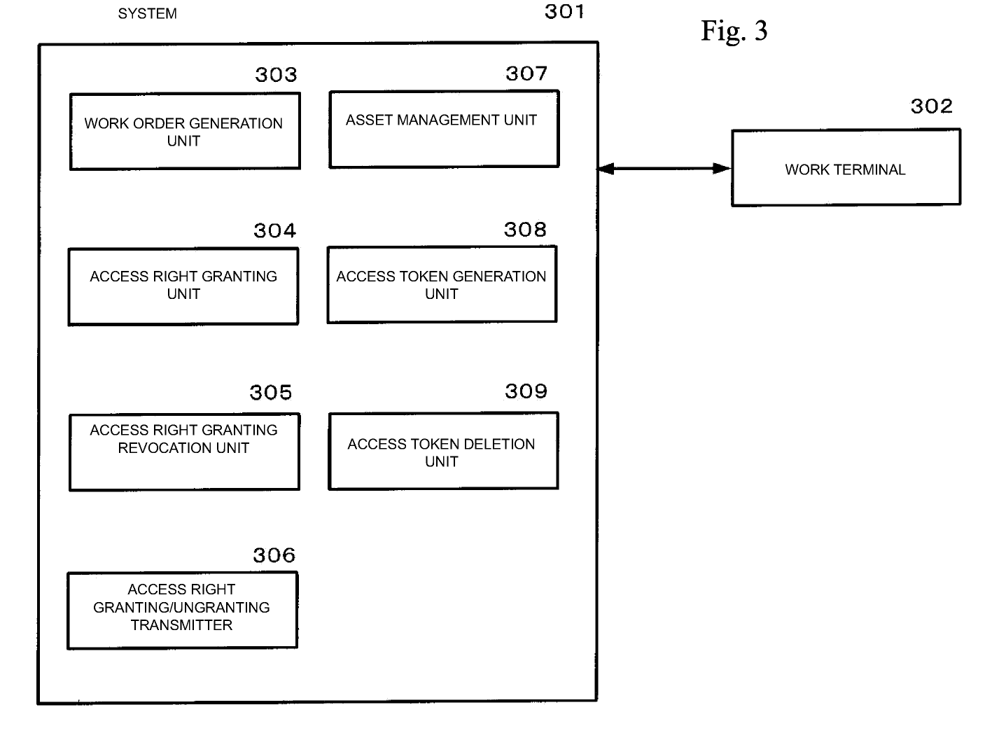

FIG. 3 is a functional block diagram of the system (201) shown in FIG. 2.

A system (301) may be an asset management system or a configuration management system. The system (301) may be connected to a work terminal (302) through a wired or wireless network as in FIG. 2.

The system (301) may include a work order generation unit (303), an access right granting unit (304), an access right granting revocation unit (305), an access right granting/ungranting transmitter (306), an asset manager (307), an access token generation unit (308), and an access token deletion unit (309).

The work order generation unit (303) issues at least one work order on the basis of a work process stored in the process database (213). The work order generation unit (303) may store the generated work order in the process database (213) or a work order database (not illustrated) as a written work order.

The access right granting unit (304) authorizes the worker entity (203) assigned to a work order to be executed to have the access right to the asset (204), the first element (205), or the second element (206) associated with the work order to be executed. The worker entity (203) is authorized at a scheduled start time for the work order to be executed, or in response to reception of a report (or a report message) indicating the start of work for the work order to be executed or a report (or a report message) indicating the completion of work for a preceding work order to the work order to be executed. The access right granting unit (304) searches, for example, the process database (213) or the CMDB ((406) in FIG. 4) for the work order. The access right granting unit (304) searches, for example, the worker entity database (216) or the CMDB (406) for a worker entity (203) that may be assigned to the work order. The access right granting unit (304) identifies the access right to the asset (204), the first element (205), or the second element (206) associated with the work order to be executed and assigns the identified access right to the worker entity (203). The access right is identified and assigned at a scheduled start time for a work order to be executed, or in response to reception of a report (or a report message) indicating the start of work for the work order to be executed or a report (or a report message) indicating the completion of work for a preceding work order to the work order to be executed.

The access right granting unit (304) may associate the access right to the asset (204), the first element (205), or the second element (206) with the work order. The access right granting unit (304) reads the access right to the asset (204), the first element (205), or the second element (206) associated with the work order, from the access right storage database (215), for example.

The access right granting unit (304) grants the access right to the asset (204), the first element (205), or the second element (206). This granting includes granting an access right to at least one of the asset (204), the first element (205), and the second element (206). For example, when assets are a generator and a pump, the access rights cannot be granted to a generator or a pump itself. In this case, it is necessary to grant the access right to the second element such as a door associated with an access path to the generator. On the other hand, when there is as an asset an IT system only, the access right to the IT system can be granted directly. In this case, it may be necessary to manage only the access right to the IT system and the granting of the access right to a first element and/or a second element associated with the IT system might not be required.

The access right granting revocation unit (305) revokes the access right granted by the access right granting unit (304) at a scheduled completion time for a work order already started, or in response to reception of a report (or a report message) indicating the completion of work for the work order already started or a report (or a report message) indicating the start of work for a succeeding work order to the work order already started. The start of work for a succeeding work order to the work order already started is a start of subsequent work whose order is next to the already started work.

The access right granting/ungranting transmitter (306) transmits the access right granting message from the access right granting unit (304), to the asset (204), the first element (205), or the second element (206). The access right granting/ungranting transmitter (306) transmits the access right ungranting message from the access right granting revocation unit (305), to the asset (204), the first element (205), or the second element (206). The access right granting unit (304) may have the function of the access right granting/ungranting transmitter (306) to transmit the access right granting message from the access right granting unit (304) to the asset (204), the first element (205), or the second element (206). The access right granting revocation unit (305) may have the function of the access right granting/ungranting transmitter (306) to transmit the access right ungranting message from the access right granting revocation unit (305) to the asset (204), the first element (205), or the second element (206). The access right granting/ungranting transmitter (306) deletes granting from the access right granting management database (214) that manages whether the worker entity (203) is authorized to access the asset (204), the first element (205), or the second element (206).

The asset manager (307) searches the asset database (212) or the CMDB (406) to find and identify the first element (205) or the second element (206) associated with the asset (204) designated in the work order.

The access token generation unit (308) generates an access token used for authorizing an access to the asset (204), the first element (205), or the second element (206) in association with the work order to be executed. The access token may be generated for each work order or each task which is the minimum unit of the work order. The access token generation unit (308) transmits the generated access token to the security device (211) carried around with the worker entity (203) authorized to have the access right. A function to transmit the access token may be performed by the separate unit (not illustrated).

The access token deletion unit (309) deletes or invalidates the access token associated with a work order to be completed or a completed work order from the security device, at a scheduled completion time for a work order already started, or in response to reception of a report (or a report message) indicating the completion of work for the work order already started or a report (or a report message) indicating the start of work for a succeeding work order to the work order already started. The access token is deleted or invalidated, for example, by the access token deletion unit (309) by transmitting a message indicating deletion or invalidation of the access token in the security device (211).

When the access right to the asset (204), the first element (205), or the second element (206) is managed online by the system (201), the following processes of (1) or (2) may be performed using the units described above.

(1) The access right granting unit (304) is inquired of whether the worker entity (203) is authorized to access the asset (204), the first element (205), or the second element (206) from the asset (204), the first element (205), or the second element (206). When the worker entity (203) is authorized to access the asset (204), the first element (205), or the second element (206), the access right granting unit (304) transmits a message indicating authorization of the worker entity (203) to have the access right to the asset (204), the first element (205), or the second element (206) that has made the inquiry. When the access right to the asset (204), the first element (205), or the second element (206) is managed online, the access right granting revocation unit (305) transmits a message indicating revocation of the authorization of the worker entity (203) to have the access right to the asset (204), the first element (205), or the second element (206) that has made the inquiry, at a scheduled completion time for a work order already started, or in response to reception of a report indicating the completion of work for the work order or a report indicating the start of work for a succeeding work order to the work order already started. When the access right to the asset (204), the first element (205), or the second element (206) is managed online, the access right granting revocation unit (305) deletes the granting of access right from the access right granting management database (214) managing whether the worker entity (203) is authorized to access the asset (204), the first element (205), or the second element (206).

(2) The access right granting unit (304) authorizes the worker entity (203) to have the access right to the asset (204), the first element (205), or the second element (206). Upon granting of the access right, the access right granting/ungranting transmitter (306) transmits a message indicating authorization of the worker entity (203) to have the access right, to the asset (204), the first element (205), or the second element (206). The asset (204), the first element (205), or the second element (206) to which the granting message is transmitted authorizes the authorized worker entity (203) to have the access right thereto. The access right granting revocation unit (305) revokes the granting of the access right for the worker entity (203), at the scheduled completion time of the work order or in response to reception of the report indicating the completion of work for the work order. The access right granting/ungranting transmitter (306) transmits a message indicating revocation of the granting of the access right, to the asset (204), the first element (205), or the second element (206) for which the access right has been granted. The asset (204), the first element (205), or the second element (206) to which the revoking message has been transmitted revokes the access right of the authorized worker entity (203).

FIG. 4 is a block diagram of the system (201) shown in FIG. 2, in a case where the system (201) is a configuration management system.

First, basic terms related to the configuration management system and the configuration management database (CMDB) are described below.

Configuration management is a process of: recognizing configuration items (hereinafter, also referred to as CIs) to be managed in IT service management; and maintaining, updating, checking, and auditing information on the configuration items.

CI is a basic unit of a management target in the IT service management. In the embodiment of the present invention, the CI includes the asset (204), the first element (205), and/or the second element (206). In the embodiment of the present invention, the CI may include the worker entity (203).

The configuration management database (CMDB) stores therein each CI's at least one attribute and a relation with another CI. The CMDB is a core of the configuration management in the ITIL framework. The CMDB, which is conceptually a database, may physically take a form of a database system or a spreadsheet provided by spreadsheet software. The use of the CMDB allows a CMDB manager to readily understand the relation between the CIs.

The configuration item instance (CI instance) is data corresponding to a CI. Each CI instance is represented as a data model instance in the CMDB. A static data instance and a Java (registered trademark) class instance are examples of the instance. An implemented Java (registered trademark) class instance is stored in the CMDB with, for example, a mechanism called Java (registered trademark) Data Objects (JDO) for persistently storing the Java (registered trademark) class instance in a hard disk. Thus, turning off the computer does not erase the generated Java (registered trademark) class instance. When the computer is restarted, the Java (registered trademark) class instance is read from a storage device, e.g., the hard disk, and loaded on a main memory as a Java (registered trademark) class instance which can be modified or deleted with a Java (registered trademark) program. In the following, the description may be given on the assumption that the CI is implemented in the CMDB as an instance.

The data model is a schema for defining the CI and is an information model providing a consistent definition of managed CIs and a relation therebetween. Specifically, the data model defines a predetermined attribute of a CI and a relation between the CI and another CI. “CDM” which is a data model for configuration management database proposed by IBM, is an example of the data model. CDM is implemented based on Unified Modeling Language (UML), for example.

Attributes identify and describe each CI for the management of CIs. Although not limited thereto, the attributes include the following: a CI name (the name of the CI, e.g., a server or a client); a product number (ID) (the number for uniquely identifying an entity to which the CI belongs, e.g., a manufacturing number, a serial number, or the like); a category (classification of the CI, e.g., an asset, a first element, or a second element); a type (further detailed description of the CI classified by the category); a model number (the CI's model number given by the provider); a warranty period (a warranty period set by the supplier of the CI); a version number (the CI's version number); a location (a location at which the CI is present, e.g., installation place, a shelf, storage); a responsible owner (the name of a person responsible for managing the CI); a responsibility start date (a date on which the responsible owner became responsible for the CI); a provider (a developer or a source of the CI); a provided date (a date on which the CI is provided for an organization); an acceptance date (a date on which the CI is accepted by the organization); a utilization start date (a date on which the CI is started to be used); a CI status (a current status, e.g., operating, tested, or failed, or a future status, e.g., a scheduled status of the CI); and a CI instance status (validity or invalidity of CI instance). Attributes required in the IT service management will be defined afterwards when necessary.

A relation represents the relation between CIs Like the CI, the relation may be defined by the data model. Examples of the relation include assigns, canConnect, canUse, connectAt, connects, controls, deployedOn, Located, Managed, Owned, provides, runAt, uses, and usedBy. Relations required in the IT service management will be defined afterwards when necessary.

A functional block diagram of the system shown in FIG. 4 is described below.

Like the system (301) in FIG. 3, a system (401) may include the work order generation unit (303), the access right granting unit (304), the access right granting revocation unit (305), the access right granting/ungranting transmitter (306), the asset manager (307), the access token generation unit (308), and the access token deletion unit (309). Alternatively, the system (401) may be connected to the system (301) in FIG. 3.

The system (401) as a configuration system may include a discovery unit (402). Still, in the embodiment of the present invention, the CI may be managed manually by a manager of the configuration system even when the system (401) does not include the discovery unit (402). The system (401) may include a CI reconciling unit (403), a CI instance generation unit (404), an attribute and relation updating unit (405), and the CMDB (406). The discovery unit (402), the CI reconciling unit (403), the CI instance generation unit (404), the attribute and relation updating unit (405), and the CMDB (406) may be implemented in a single computer or dispersedly implemented in multiple computers. The system (401) further includes a discovery table (407), a model table (408), and a relation table (409). The tables may be implemented in a storage device in a single computer or dispersedly implemented in storage devices in multiple computers. The system (401) is connected to a display device which may display a console screen (410) of a Tivoli Application Dependency Discovery Manager (hereinafter, abbreviated as TADDM), for example. The console screen (410) shows a connection relation between a CI (an asset A) and a CI (an element B). The connection relation between the CI (asset A) and the CI (element B) shown in the console screen (410) is an example and does not represent all the CIs and connection relations between the CIs managed by the system (401).

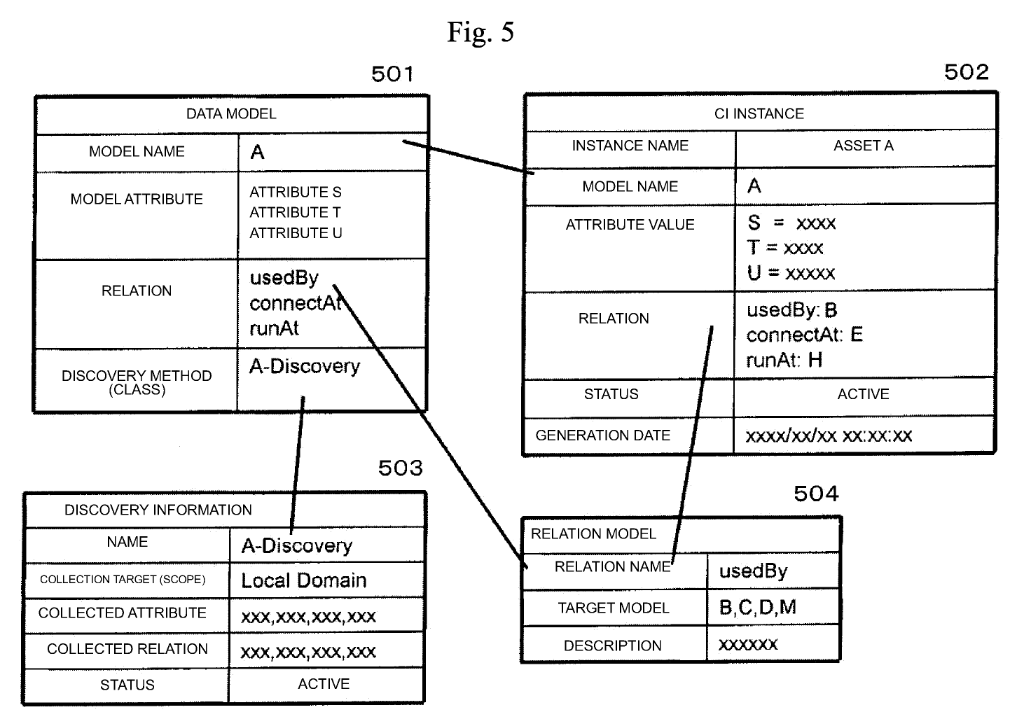

The discovery unit (402) detects (or “discovers” in another expression) information related to CIs managed by the CMDB (406). The system (401) may include multiple discovery units (402). Preferably, a management target is connected to the system (401) through a network. The network may be in wired or wireless connection. A manager of the system (401) may set the detection target as desired. The detection range may be set by a domain name, an IP address, a MAC address, a device identifier, a database name, or a combination of these. When a CI as the management target is industrial equipment, information on the industrial equipment is detected. The detected information may be information on a new CI, or an updated value of an attribute or a relation of an existing CI. The new CI is a CI detected by the discovery unit (402) but not registered in the CMDB (406). The existing CI is a CI of which the instance is already registered in the CMDB (406). The discovery unit (402) detects the information on the CI on the basis of discovery information (e.g., A-Discovery) (503 in FIG. 5) stored in the discovery table (407). Which discovery information should be used is designated by a discovery method in a data model (501 in FIG. 5). The discovery unit (402) passes the detected information on the CI onto the CI reconciling unit (403).

The CI reconciling unit (403) receives the information on the CI from the discovery unit (402) and processes the detection result. The CI reconciling unit (403) determines whether the information on the CI is information on a new CI or an updated attribute or relation value of an existing CI with reference to the CMDB (406). The determination may be performed, for example, by checking the information on CI against the CI instance names stored in the CMDB (406). When the information on the CI is information on a new CI, the CI reconciling unit (403) passes the information onto the CI instance generation unit (404). On the other hand, when the information on the CI is an updated attribute and relation value of an existing CI, the CI reconciling unit (403) passes the information onto the attribute and relation updating unit (405).

The CI instance generation unit (404) generates one set of data indicating a predetermined attribute of the CI and a relation between the CI and another CI on the basis of the information on the CI and in accordance with the data model (501 in FIG. 5) stored in the model table (408) and a relation table (504 in FIG. 5) stored in the relation table (409). The one set of data is instantiated on the basis of the information on the CI detected by the discovery unit (402) or manually inputted information on the CI. The one set of data may be implemented with a static data instance or a Java (registered trademark) class instance. An example of the one set of data is a CI instance (502 in FIG. 5). The one set of data is stored in the CMDB (406). The one set of data may have an attribute and a relation in the CI instance (see 502), or have an attribute in the CI instance but be stored as a relation instance separately in the CMDB (406). In the latter case, the CI instance has a linking for identifying the relevant relation instance.

The attribute and relation updating unit (405) cooperates with the discovery unit (402) for implementing tracking. The attribute and relation updating unit (405) reflects an updated attribute or relation value of a CI on a CI instance of the CI stored in the CMDB (406), i.e., updates the attribute or relation value of the CI instance of the CI. The update is performed by replacing the value with the information on the CI detected by the discovery unit (402). In the replacement, all the values of the attributes and the relations of the CI instance may be replaced by the information detected by the discovery unit (402), or only different values different from those in the information may be replaced.

The CMDB (406) records the CI instance (502) of the CI.

The discovery table (407) stores therein discovery information (503 in FIG. 5). The discovery unit (402) uses the discovery information (503) for detecting information on a CI. The discovery information (503) may be implemented with a static data instance or a Java (registered trademark) class instance, for example. The discovery information (503) is also called a discovery policy. The discovery information (503) includes a collection target (scope) which is a range searched by the discovery unit (402), i.e., a range of search for a CI, a collected attribute, and a collected relation. The collection target may be specified using, for example, a subnet IP address, a range of an IP address, an individual IP address, a MAC address, a device identifier, a hostname, a database name, or a combination of these. As another mode, the collection target may be a schedule management database (not illustrated) connected to the system (401) through the network. The schedule management database stores therein, for example, data related to process management using a device. As yet another mode, the collection target may be a database (not illustrated) storing therein a batch process definition file. When the collection target is the database storing therein a batch process definition file, the discovery unit (402) performs detection by loading the content of the batch process definition file. The batch process definition file stores therein data indicating a sequence in which the devices are to be used, for example.

The model table (408) stores therein the data model (501). The CI instance generation unit (404) uses the data model (501) for generating one set of data indicating a predetermined attribute of the CI and the relation between the CI and another CI.

The relation table (409) stores therein a relation model (504 in FIG. 5). The CI instance generation unit (404) uses the relation model (504) for generating one set of data indicating a predetermined attribute of the CI and the relation between the CI and another CI.

FIG. 4 shows a case where the discovery unit (402) detects information on an asset and an element as management targets, the asset and the element being connected to the system (401) through the network. As a result, the discovery unit (402) detects information on the asset A and the element B associated with the asset A. Then, the CI reconciling unit (403) determines whether the information is information on a new CI with reference to the CMDB (406). Based on the determination result, the CI instance generation unit (404) generates CI instances of the asset A and the element B as well as an instance of the relation (usedBy) between the asset A and the element B. Then, the instances are stored in the CMDB (406).

FIG. 5 shows the data model (501) stored in the model table (408), the CI instance (502) (of the asset A) stored in the CMDB (406), the discovery information (503) stored in the discovery table (407), and the relation model (504) stored in the relation table (409) that are used in the system (401) in FIG. 4.

The data model (501) is a schema for defining a CI. For example, the data model (501) includes a “model name” specifying a CI, a “model attribute” indicating an attribute of the CI specified by the model name, a “relation” that the specified CI may have between that CI and another CI, and a “discovery method” for identifying the discovery information for detecting the CI specified by the model name. The “model attribute” may be specified in accordance with the attribute specified in the data model “CDM” for the configuration database proposed by IBM, for example, but is not limited thereto. A manager of the CMDB (406) may specify desired attributes in the data model (501) at his/her discretion. The “relation” is specified in accordance with the relation specified in the CDM, for example, but is not limited thereto. The “discovery method” may be specified by the discovery information name, which is A-Discovery in FIG. 5.

The discovery information (503) includes descriptions of: a “name” of the discovery information specified by the “discovery method”; a “collection target (scope)” of a management target (CI) to be collected by the discovery unit (402); a “attributes to collect” and a “relation to collect” of management target (CI) to be collected by the discovery unit (402); and a “status” indicating that the discovery information is active or inactive.

The CI instance (502) includes descriptions of: an “instance name” for identifying a CI to which the instance belongs; a “model name” indicating the data model used to generate the instance; an “attribute value” of each attribute specified by the data model; a description (value) of a “relation” specified by the data model; a “status” indicating that the instance is active or inactive; and a “generation date” of the CI instance. Preferably, the CI instance further includes a CI instance identifier unique to each CI instance. The CI instance identifier, which may be of any kind as long as the CI instance can be distinguished from other CI instances therewith, for example, a hostname, a serial number, or a combination of other attributes which have permanent values may be used. The CI instance (502) indicates that: the CI instance is a CI instance of a device A; the CI instance is instantiated using the data model A; the CI instance has attributes S, T, and U which individually have values; as a relation, the device A is used by B (usedBy: B), connected to E (connectAt: E), and runs on H (runAt: H); and the CI instance is active, as well as the date on which the CI instance is generated.

The relation model (504) is a schema for defining a relation specified by the data model (501). The relation model (504) includes descriptions of a “relation name” such as usedBy, a “target data model” for specifying the target data model for the relation, and an “explanation” of the relation.

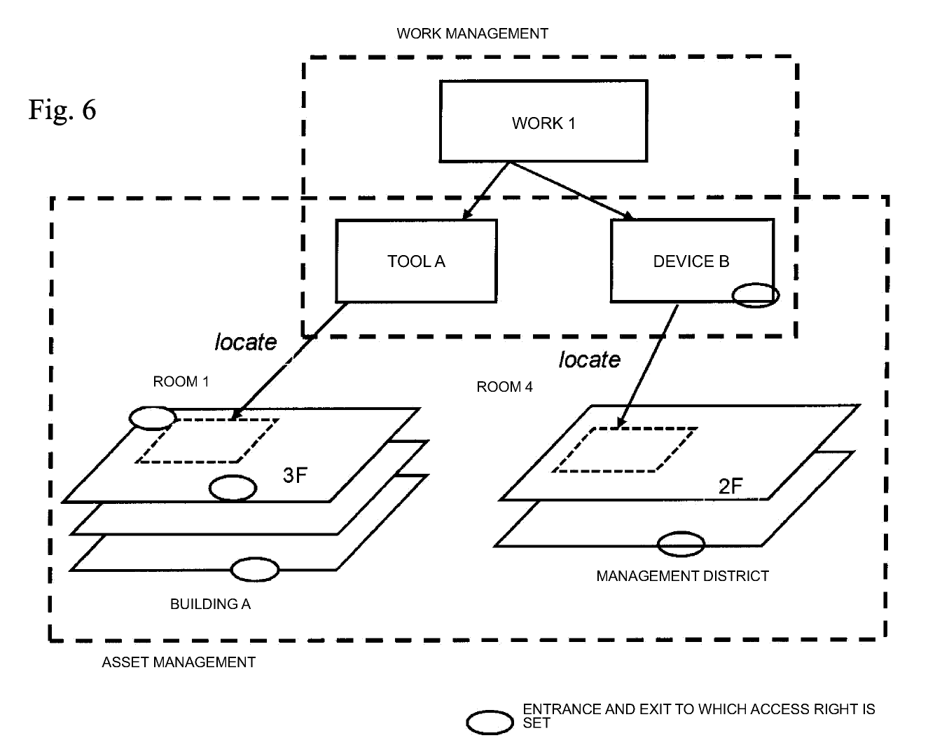

FIG. 6 shows management subjects of the systems (201, 301, and 401) shown in FIGS. 2 to 4. In the following, the systems (201), (301), and (401) may be simply referred to as the system (201).

The system (201) manages an asset (e.g., a device B) and a first element (e.g., a tool A) associated with the asset and the locations thereof. As indicated by an arrow in FIG. 6, the device B is on the second floor in a managed district B. As shown in an arrow in FIG. 6, the tool A associated with the device B is in a room 1 on the third floor of a building A. The tool A is used for maintaining the device B.

The system (201) manages whether an access right is required for operating the asset or the first element. Thus, when accessing the asset or the first element to which access control is applied, a worker entity (203) has to be authorized to have the access right thereto.

The system (201) manages which entrance/exit in the managed district B and the building A has controlled access. Thus, when accessing the entrance/exit to which the access control is applied, the worker entity (203) has to be authorized to have the access right thereto.

The system (201) performs work management which is a maintenance work on the asset and the first element on the basis of the work process. The system (201) issues one or multiple work orders on the basis of the work process. A work order (Work 1) in FIG. 6 is as follows:

(Work 1) Maintain the device B; use the tool A for maintaining the device B.

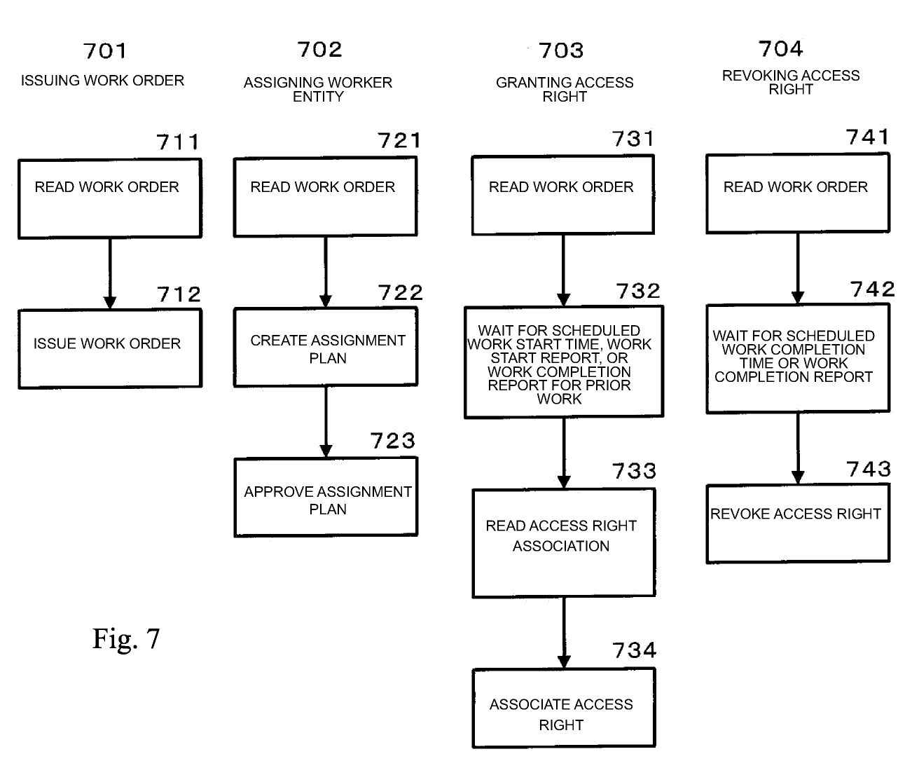

FIG. 7 shows processes performed for the access right management of the embodiment of the present invention using the system (201) shown in FIG. 2.

Processes for managing an access right according to the embodiment of the present invention includes: issuing a work order (701); assigning a worker entity (203) (702); granting an access right (703); and revoking the access right (704). The processes are performed in this order. The steps of issuing a work order (701) and assigning a worker entity (203) (702) may be performed contiguously or discontiguously in terms of time. When the steps are performed contiguously in terms of time, the steps 701 to 704 are contiguously performed. When the steps are performed discontiguously in terms of time, for example, the work order is issued (701) seven days before the work start deadline, the worker entity (203) is assigned (702) six days before the deadline, the access right is granted (703) on the work start date, and the access right is revoked (704) upon completion of the work. When the access right is granted (703) or the access right is revoked (704) based on the time, for example, the system (201) searches the process database (213) at regular intervals to find a work order of which the scheduled start or completion time has come. When such a work order is found, the system (201) grants the access right (703) or revokes the access right (704).

1. Issuing Work Order (701)

The work order generation unit (303) of the system (201) reads a work process from the process database (213) (Step S711). On the basis of the work process thus read, the work order generation unit (303) issues a work order (Step S712). Alternatively, the work order may be issued by a person in a department managing the work (hereinafter, also referred to as a work manager) by retrieving the work process (which may or may not be in a digital format) (Step S711), and creating and issuing the work order (Step S712). The created work order is inputted to the system (201) to be managed by the system (201).

The work order may be changeable by the work manager after being issued. The work order may be received by the system (201) as an official work order only after the approval of the work manager.

One or multiple work orders are issued depending on the content of the work process.

The work order may be issued, for example, two weeks or right before the work is started, or upon reception of a completion message for a prior work. Upon being issued, the work order may be stored in the process database (213) or the work order database (not illustrated) of the system (201). The work order may be delivered to the worker entity (203) in a message format such as an e-mail upon being issued or at a point near the scheduled work start date. The work order may be delivered to the worker entity (203) in a physical format such as a printed matter upon being issued or at a point near the scheduled work start date.

In Maximo (registered trademark), a maintenance procedure is defined depending on the type of an asset, and a tool and the like are specified in the procedure. In Maximo (registered trademark), when the work order is generated, a first element and a second element may be associated with a work order by applying the maintenance procedure.

2. Assigning Worker Entity (702)

The work order is assigned to the worker entity (203). The work order is assigned to the worker entity (203) by the system (201) or by the work manager by using the system (201).

When the system (201) assigns the work order to the worker entity (203), the system (201) reads the work order from the process database (213) (Step S721). The system (201) can extract worker entity (203) candidates from the worker entity database (216) on the basis of information associated with work-assigned entities (203). For example, the system (201) may extract the worker entity (203) candidates on the basis of information on a schedule, an already assigned work amount, and a transport path of the work-assigned entities (203), as well as a qualification, a skill, and years of experience of the work-assigned entities (203). Then, the system (201) assigns the worker entity (203) candidates to the work order (Step S722).

When the work manager assigns the worker entity (203) to the work order by using the system (201), the work manager extracts a work process (which may or may not be in a digital format) (Step S721) and assigns the worker entity (203) to the work order (Step S722). The work manager assigning the worker entity (203) to the work order by using the system (201) can make the determination outside the system (201) at his or her discretion. For example, the work manager can assign a worker XX with a worker YY to a work A because the work manager wants the worker XX to be well-experienced with the work A. The work manager inputs the result of the assignment of the worker entity (203) to the work order, to the work order through the system (201).

3. Granting Access Right (703)

In the management and the maintenance of the asset based on a work process, the access right needs to be granted so that only the worker entity (203) assigned the work order can access the asset, the first element, and the second element as work subjects. The access right is granted by associating the access right with a subject for which the access right is to be granted.

The access right granting unit (304) of the system (201) reads the work order (Step S731) and reads data required for the association of the access right. For example, the data may be: the worker entity (203); a scheduled work start time; an asset, a first element, or a second element as a work subject; hierarchical information on the work order; or a place, of the work order, in the sequence.

The access right to an asset is a right to operate or dispose of the asset. The access right to a first element is a right to operate or dispose of the first element. The access right to the second element is a right to open or close (typically unlock) the second element.

The asset to be associated with the access right is read from the work order. When the first element to be associated with the access right is designated in the work order, the first element is read from the work order. When no first element to be associated with the access right is designated in the work order, the system (201) may search the asset database (212) or the CMDB (406) for the first or the second element associated with the asset designated in the work order.

The second element, i.e., an element associated with an access path to the asset or the first element, is automatically determined as in the following examples.

(1) The work process is assumed to be a routine inspection on an air conditioner. Thus, the asset is the air conditioner. The air conditioner is assumed to be designated in association with work in the work order. The system (201) accesses the process database (213) and determines that the asset is the air conditioner based on the work order. The system (201) determines that the first element is an oxymeter required for inspecting the air conditioner based on the work order. The system (201) accesses the asset database (212) or the CMDB (406) and determines that the second elements are a machine room in which the air conditioner is installed and a warehouse in which the oxymeter is stored. Thus, the system (201) determines that access rights to the machine room and the warehouse are required for the routine inspection on the air conditioner.

(2) The work process is assumed to be a backup operation for a server. Thus, the asset is the server. A tape device is an element, i.e., the first element associated with the server. The work order is assumed to designate the server as the asset and the tape device as the first element. The work order is assumed to designate the backup operation as the following processes: taking a tape from a tape storage; mounting the tape in the tape device; backing up the server on the mounted tape; and returning the tape to the tape storage upon completion of the backup. The system (201) determines that the asset is the server and the tape is the first element on the basis of the work order. The system (201) accesses the asset database (212) or the CMDB (406) and determines that the second elements are a server room in which the server is installed and the tape storage in which the tape is stored. Thus, the system (201) determines that the access rights to the server room and the tape storage are required for the server backup operation.

The access right is associated at the scheduled work start time of the worker entity (203), or in response to reception of a report indicating the start of work or a report indicating the completion of prior work (Step S732). When multiple work orders, in particular, are managed in a predetermined sequence, the start of work next to work about to start may be triggered by the report indicating the completion of the preceding work. In this case, the report indicating the completion of the preceding work also serves as the report indicating the start of the work about to start. Thus, the system (201) records the start of the work about to start upon receiving the report indicating the completion of the preceding work.

For example, when the access right is granted in response to reception of the report indicating the start of the work about to start or the report indicating the completion of preceding work, the selection of the work about to start and reporting the start of the work about to start or the selection of the preceding work and reporting the completion of the preceding work may trigger the reading the association of the access right (step S733) and granting access rights (access rights is granted) (Step S734).

The access right granting/ungranting transmitter (306) transmits an access token to the security device of the worker entity (203) to be authorized to have the access right to the asset, the first element, or the second element when the access right is granted as required.

4. Revoking Access Right (704)

The access right granting revocation unit (305) of the system (201) reads the work order (Step S741) and instructs the access right granting/ungranting transmitter (306) to transmit an instruction to revoke or invalidate the access token at a scheduled completion time, or in response to reception of a report indicating the completion of work for the work order already started or a report indicating the start of work for a succeeding work order to the work order already started (Step S742). The access right granting/ungranting transmitter (306) transmits the instruction to revoke or invalidate the access token to the security device (211) of the worker entity (203) for which the access right is to be revoked (Step S743) to revoke the access right.

For example, when the access right is revoked in response to reception of the report indicating the completion of the current work or the report indicating the start of succeeding work, revoking the access right may be triggered by the following operation. Specifically, the revoking the access right is triggered when an operator selects a work order for which the completion of the current work or the start of the next work is to be reported and makes the selected report.

When the entrance/exit is completely controlled online, instead of transmitting the access token to the security device and storing the access token therein, granting the access right (703) may be performed by the following processes.

1. Method Using Central Server

The entrance/exit is assumed to be completely controlled online and the system (201) is assumed to inquire a central server for any decision to grant the access right or not. In this case, after the asset, the first element, or the second element (access target) is identified, the access right to the access target of the security device (211) owned by the worker entity (203) is dynamically registered in the central server. In response to the inquiry from the asset, the first element, or the second element, the central server determines whether the worker entity (203) has the access right and returns the determination result to the asset, the first element, or the second element that has made the inquiry. The asset, the first element, or the second element receiving the result grants the access right when the result indicates that the worker entity (203) has the access right. Upon receiving the work completion report from the worker entity (203), the system (201) transmits an instruction to the central server to delete the granted access right. Upon receiving the deletion instruction, the central server deletes the access right of the worker entity (203) that has reported the work completion.

As described above, in the method using the central server, the access right is granted by inquiring the central server for the determination to grant the access right or not every time the access is to be made.

2. Method Using Access Target Determination Device

An access target determination device includes the functions of the access right granting unit (304) and the access right granting revocation unit (305) in FIG. 3.

Entrance/exit is assumed to be completely controlled online and the access target determination device is assumed to be connected to the system (201) online. In this case, after the access targets are identified, the access target determination device notifies each access target of the change in access policy for the worker entity (203) (access right is granted). Upon receiving the work completion report from the worker entity (203), the system (201) transmits, to the access target determination device, an instruction to change the access policy for the worker entity (203) (access right is revoked). Upon receiving the change instruction, the access target determination device notifies each access target of the change in the access policy for the worker entity (203) (access right is revoked).

As described above, in the method of using the access target determination device, the access right is managed as follows. Specifically, the access target determination device notifies each access target of the access right in advance and, for example, a door controller as the second element determines whether or not the worker entity (203) has the access right to the door controller on the basis of the access right notified in advance.

In the access right management method according to the present invention, the system (201) authorizes the worker entity (203) to which the work order is assigned to have the access right, at the scheduled work start time described in the work order, or in response to reception of the report indicating the start of work or the completion of prior work. The system (201) revokes the access right in response to reception of a report indicating the completion of work or predetermined time period after the reception of the report indicating the completion of work. Thus, the access right management method according to the embodiment of the present invention has the following advantages.

According to the embodiment of the present invention, security can be improved because the access right to the asset, the first element, and the second element as the work subjects are authorized only in a time zone in which the work needs to be performed. For example, generally, entrance is constantly permitted for the routine work such as replacing the backup data every Monday morning. However, according to the embodiment of the present invention, security is improved because the access right to the asset, the first element, and the second element as the work subjects is only authorized in the time zone designated for the routine work.

According to the embodiment of the present invention, there is no need to grant the access right for all the time. Thus, even when the worker entity (203) is transferred to another department or resigns, revocation of the access right can be prevented from being forgotten.

According to the embodiment of the present invention, the following case can be prevented. Specifically, when a worker entity (203) A is sick out of work and an operator B is temporarily assigned to the work, the operator B assigned the work cannot enter the work location because the security system is not updated.

For the work including multiple steps, combination of the known technique in which succeeding work can be performed only after the current work and the technique according to the embodiment of the present invention can achieve the following. For example, the access right for entering an incinerator for cleaning work can be granted only after the completion of work for checking that the temperature in the incinerator fell to or below a certain temperature and the oxygen level in the incinerator is equal to or higher than a predetermined level. Granting the access right in such timing can force the worker entity (203) to observe the process for protecting his or her safety.

Examples of A. Printer Maintenance, B. Incinerator Cleaning, and C. Database Configuration Change according to the embodiment of the present invention are described below.

A. Example of Printer Maintenance

1. Issuing Work Order

On the basis of a stipulation in a “printer maintenance process,” a work order for printer maintenance is issued periodically (e.g., once in every three months), once in every predetermined time period (e.g., 24 hours), or when a predetermined amount (e.g., 3000 sheets) of sheets of paper are printed. The work order may be designed to require an approval by a work manager before issuance thereof. In the work order, a target execution date or an execution date and time, or a target execution period (e.g., Sep. 1, 2010 or Sep. 1, 2010 12:00; or Sep. 1, 2010 to Sep. 10, 2010) is designated on the basis of the stipulation in the printer maintenance process.

2. Identifying Asset

The work order designates a particular printer (e.g., a printer AAA1) as a work subject. The system (201) may recognize the work subject, i.e., the printer AAA1, as the asset on the basis of the work order.

3. Identifying Element Associated with Printer

In the example of printer maintenance, the access right may be set for the printer itself or may also be set for an element associated with an access path to the printer. Thus, for example, the system (201) reads the work order and recognizes an element associated with an access path to the printer AAA1 on the basis of the work order. Alternatively, the system (201) searches, for example, the asset database (212) or the CMDB (406) for the element associated with the access path to the printer AAA1.

The system (201) searches the asset database (212) or the CMDB (406) to find, as the access path to the printer AAA1, for example, a printer room (e.g., the second printer room on the fifth floor of a building A) in which the printer AAA1 is installed, an office area (e.g., the north area on the fifth floor of the building A) including the printer room, a front gate for entering a building (e.g., the building A) including the office area. Then, the system (201) recognizes doors for controlling the entrance to the printer room, the office area, and the front gate as elements associated with the access path to the printer AAA1.

In addition, the maintenance process for the printer AAA1 is assumed to designate replenishing toner and/or cleaning a drum for the printer. For example, the system (201) reads the work orders and recognizes toner usable in the printer AAA 1 and a cleaning utensil (e.g., a vacuum cleaner provided with a suction tool for the drum) designated in the maintenance process, as elements associated with the printer AAA1 and as elements associated with the work order for the asset. Alternatively, the system (201) searches the asset database (212) or the CMDB (406) for the elements associated with the printer and recognizes the toner usable in the printer AAA1 and cleaning utensil (e.g., vacuum cleaner provided with a suction tool for the drum) designated in the maintenance process as the elements associated with the printer AAA1.

Meanwhile, it is assumed that the toner is stored in a stock room, for example, and the vacuum cleaner is stored in the printer room, for example. Thus, a worker has to enter (access) the stock room for the printer maintenance work. Accordingly, the worker has to have an access rights to elements associated with an access path to the stock room in addition to the access rights to the elements associated with the access path to the printer room. For example, when the stock room is provided in the same office area as the printer room, the access right to the office area needs not to be redundantly given and only the access right to the stock room is required. As another example, when the stock room is not provided in the same office area as the printer room and the entrance to the stock room is controlled, the worker has to have access rights to doors for controlling the entrance to an office area (e.g., the south area on the fifth floor of the building A) including the stock room and to a door for controlling the entrance to the stock room in addition to the access rights to the doors for controlling the entrance to the office area (e.g., the north area on the fifth floor of the building A) including the printer room.

4. Assigning Worker Entity to Maintenance Work

For assigning a worker to the maintenance work, several patterns as described below are conceivable.

(1) The system (201) automatically generates a worker assignment plan for the maintenance work in consideration of: a qualification or a skill of a worker; a work schedule of the worker on the day of the maintenance work; whether the worker is scheduled to visit the maintenance work location (the building A or a facility including the building A) on the day of the maintenance work; and the like. By using the system (201), the work manager can modify the generated assignment plan and approve the generated assignment plan or the modified assignment plan.

(2) The work manager assigns the maintenance work to the worker by using the system (201), e.g., an assignment manager function of Maximo (registered trademark). In this pattern, since the work manager assigns the maintenance work to the worker, approval of the assignment plan may be omitted as long as no approval of a higher level manager is required.

(3) An optimum arrangement system that is independent from the system (201) and minimizes the traveling time of the worker automatically generates a worker assignment plan for the maintenance work in consideration of the work locations for other works. By using the system (201), the work manager can modify the generated assignment plan and approve the generated assignment plan or the modified assignment plan. Although the optimum arrangement system is not a subject matter of the present invention, a person skilled in the art can appropriately select the optimum arrangement system usable in the embodiment of the present invention.

(4) The work manager assigns the maintenance operation to the worker without using the system (201) and inputs the assignment result to the system (201).

As described in the patterns (1) to (4), assigning the worker for the maintenance work secures the worker required for the maintenance work and thus, a scheduled execution date and time for the work order can be determined. For example, the scheduled execution date and time may be the same as the target execution date and time and specified to be Sep. 1, 2010, 12:00.

5. Assigning Access Right to Worker Entity

It is assumed that a worker B as the worker is assigned the maintenance work. In response to the issuance of the work order for the maintenance work, the system (201) identifies the access right required for the maintenance work and assigns the identified access right to the worker B at a scheduled start time, a predetermined time before (e.g., an hour before) the scheduled start time, or when the worker B reports the start of maintenance work to the system (201). However, when a work order about to start among multiple work orders for the maintenance work which are to be performed in a predetermined sequence is not the first work order in the sequence, the following may take place depending on the necessity to comply with the sequence. Specifically, the status of the prior work order is checked, and if the completion of the prior work order has not been reported, the access right may not be given to the work order that is not the first work order.

6. Starting Maintenance Work

When an IC card is used, the worker B uses the IC card to log into the system (201). In a case of an IC card is a contact type, the IC card is inserted into an IC card reader or an IC card reader/writer. In a case of a non-contact type, the IC card is held over the IC card reader or the IC card reader/writer and then the start of the maintenance work on the printer AAA1 is reported.

Upon receiving the report indicating the start of the maintenance work, the system (201) issues a token required for the access on the basis of the access right identified in Step 5 above. The token may include a work order number or an identification number (ID). The token may further include at least one of: a security door number; a default expiration date calculated on the basis of the scheduled work completion time; and a token number, for example. The work order number or the identification number (ID) may be used for specifying a token to be deleted. The identification number (ID) is any number generated and associated with the work order number by the system (201). The token is transmitted to the IC card reader/writer in which the IC card of the worker B is inserted or over which the IC card is held. The IC card reader/writer stores the token in a storage medium, e.g., a non-volatile memory, in the IC card.

The worker B uses the system (201) to check the printer AAA1 as the work subject and the work order.

The worker logs off from the system (201) after the token is stored in the IC card.

7. Executing Maintenance Work

Using the IC card in which the token is stored, the worker B accesses the asset (the printer AAA1) and the locations (the office area and the stock room) to execute the assigned work following the work order.

8. Completing Maintenance Work

Upon completing the maintenance work, the worker B again logs into the system (201) by using the IC card to report the completion of the maintenance work on the printer AAA1.

Upon receiving the report indicating the completion of the maintenance work from the worker B, the system (201) deletes the token associated with the maintenance work from the IC card.

When reporting the completion of the maintenance work is mandatory for the worker B but no report has been received at the scheduled completion time for the maintenance work, the system (201) detects a work delay as part of work management. Then, the system (201) transmits an alarm message to a predetermined person, e.g., a maintenance manager of the printer AAA1. Whether the access right is to be revoked due to the work delay depends on the stipulation designated in the work process. For example, the system (201) can perform the following operation in case of a possible maintenance work delay. Specifically, the system (201) repeatedly transmits the alarm message to the maintenance manager for a predetermined period, e.g., for an hour, without revoking the access right. Alternatively, when the scheduled work completion time has been set in consideration of a delay time, the system (201) revokes the access right immediately and transmits the alarm message to a security staff in charge of the office area in which the printer AAA1 is provided.

Meanwhile, suppose a case where the token is recorded in the IC card of the worker B but the security doors for accessing the printer AAA1 are not connected online to the system (201). In this case, unless the worker B again logs into the system (201) and reports the work delay, the access rights to the security doors expire after the expiration date included in the token. On the other hand, if the worker B again logs into the system (201) and reports the work delay, the work delay report also serves as application for access right extension, thus may prevent the access right from expiring after the expiration date included in the token has reached and may extend the expiration date for a predetermined time period, e.g., an hour.

When reporting the completion of the maintenance work is not mandatory, the system (201) may revoke the access right at the scheduled work completion time for the maintenance work. The system (201) may also set the expiration date in the token at the scheduled work completion time.

B. Example of Incinerator Cleaning

1. Issuing Work Order

In accordance with a stipulation in an “incinerator cleaning process,” the work order for the incinerator cleaning is issued periodically (e.g., once a month), once in every predetermined time period (e.g., once in every 700 hours), or when a predetermined amount (e.g., 100 tons) of garbage has been incinerated. The work order may be designed to require an approval by a work manager before issuance thereof. In the work order, a target execution date or an execution date and time, or a target execution period (e.g., Sep. 1, 2010 or Sep. 1, 2010 8:00 to Sep. 2, 2010 8:00; or Sep. 1, 2010 to Sep. 14, 2010) is designated on the basis of the stipulation in the incinerator cleaning process.

The incinerator cleaning process is assumed to designate the following works to be done in the following sequence.

Work 1 Stopping Incinerator Operation by Operator

Work 2 Checking Temperature and Oxygen Level in Incinerator by Safety Staff Predetermined Period of Time After Stopping Operation

Work 3 Executing Incinerator Cleaning by Cleaning Staff

Work 4 Starting Incinerator Operation by Operator

2. Identifying Asset

The work order designates an incinerator or a particular incinerator (e.g., an incinerator B) from multiple incinerators as a work subject. The system (201) may recognize the work subject, i.e., the incinerator B, as the asset on the basis of the work order.

3. Identifying Element Associated with Incinerator

In the incinerator cleaning, the access right may be set for the incinerator itself and may also be set for an element associated with an access path to the incinerator. Thus, the system (201) reads the work order and recognizes an element associated with an access path to the incinerator B on the basis of the work order. Alternatively, the system (201) searches, for example, the asset database (212) or the CMDB (406), for the element associated with the access path to the incinerator B.

The system (201) extracts as the access path to the incinerator B, an entrance door of the incinerator B, an incinerator building in which the incinerator B is installed, and a facility including the incinerator building. The system (201) recognizes the entrance door of the incinerator, the gate of the incinerator building, and the gate of the facility as the elements associated with the access path to the incinerator.

The incinerator cleaning process is assumed to stipulate a worker to wear a helmet, a dust mask, and a safety glove for his or her safety. The system (201) recognizes the safety utensils which are stipulated to be worn in the work process as elements associated with the incinerator B and as the elements associated with the work order for the asset.

The helmet, the dust mask, and the safety glove are assumed to be stored in a work tool warehouse X. Thus, the worker has to enter (access) the work tool warehouse X for the cleaning work on the incinerator B. Accordingly, the worker has to have access rights to elements associated with an access path to the work tool warehouse X in addition to the access rights to the elements associated with the access path to the incinerator B. For example, when the work tool warehouse X is in an incinerator building in which the incinerator B is installed, the access right to the incinerator building needs not to be redundantly given and only the access right to the work tool warehouse X is required. For example, when the work tool warehouse X is not in the same incinerator building as for the incinerator B and entrance to the work tool warehouse X is controlled, the worker has to have access rights to doors for controlling the entrance to the facility including the work tool warehouse X and a door for controlling the entrance to the work tool warehouse X in addition to the access rights to the doors managing the entrance to the incinerator building including the incinerator B.

In the following description, the work tool warehouse X is assumed to be in the incinerator building.

4. Assigning Worker Entity to Cleaning Work

For assigning a worker to the cleaning work, several patterns as described below are conceivable, for example.

(1) The system (201) automatically generates a worker assignment plan for the cleaning work in consideration of: a qualification or a skill of a worker; a work schedule of the worker on the day of the cleaning work; whether the worker is scheduled to visit the cleaning work location on the day of the cleaning work; and the like. By using the system (201), the work manager can modify the generated assignment plan and approve the generated assignment plan or the modified assignment plan.

(2) The work manager assigns the cleaning work to the worker by using the system (201), e.g., the assignment manager function of Maximo (registered trademark). In this pattern, since the work manager assigns the cleaning work to the worker, approval of the assignment plan may be omitted as long as no approval of a higher level manager is required.

(3) An optimum arrangement system that is independent from the system (201) and minimizes the traveling time of the worker automatically generates a worker assignment plan for the cleaning work in consideration of the work locations for other works. By using the system (201), the work manager can modify the generated assignment plan and approve the generated assignment plan or the modified assignment plan. Although the optimum arrangement system is not a subject matter of the present invention, a person skilled in the art can appropriately select the optimum arrangement system usable in the embodiment of the present invention.

(4) The work manager assigns the cleaning work to the worker without using the system (201) and inputs the assignment result to the system (201).

As described in the patterns (1) to (4), assigning the worker for the cleaning work secures the worker required for the cleaning work and thus, the scheduled execution date and time for the work order can be determined. For example, the scheduled execution date and time may be the same as the target execution date and time and specified to be Sep. 1, 2010, 8:00, for example.

5. Assigning Access Right to Worker Entity

In the present example, it is assumed that an operator of the incinerator needs to be authorized to access a control room in which the incinerator operation can be instructed to be stopped and started, but the operator is always allowed to enter the control room.

The cleaning work on the incinerator B is based on the incinerator cleaning process. Thus, the cleaning work time is determined based on the time zone in which the operation of the incinerator B can be stopped, the cleaning work time is recorded in the work order, and then the worker for the cleaning is assigned. However, the incinerator cleaning process stipulates that the operator and a safety staff need to be assigned in addition to the cleaning staff required for the cleaning work. In the present example, it is assumed that a single worker performs the cleaning work and workers P, Q, and R are respectively assigned as the operator, the cleaning staff, and the safety staff.

6. Starting Cleaning Operation

In the present example, reporting start and completion for each of Works 1 to 4 above is assumed to be mandatory for the safety check.

(1) Starting and Completing Work 1

For starting the cleaning work, the operator P logs into the system (201) with a PDA having a wireless communication function and reports the start of work to stop incinerator operation for the cleaning work. In the present example, the operator P, who is the operator, is registered in an entrance and exit control system to be always allowed to enter the operation control room. Thus, the system (201) does not change the access right of the operator P for entering the operation control room. The operator P stops the operation of the incinerator B and records the result if necessary. Then, the operator P logs into the system (201) by using the PDA and reports the completion of Work 1

(2) Starting and Completing Work 2

Upon receiving the work completion report from the operator P, the system (201) allows the safety staff R to start work for checking the temperature and oxygen level in the incinerator B. However, in accordance with the stipulation in the incinerator cleaning process, the system (201) refuses to receive the work start report from the safety staff R unless a predetermined time has passed since the completion of the work by the operator P. If the safety staff R is not authorized to have a right to always access the work location for checking the temperature and the oxygen level in the incinerator, the system (201) authorizes the safety staff R to have the access right after a predetermined time has passed since the operator P reported the completion of work or on the basis of the work start report by the safety staff R.

When the door to the warehouse and the gate are connected online to the system (201), the system (201) may authorize the cleaning staff Q to have the access right to the elements associated with the access paths to the work tool warehouse X, the incinerator building, and the gate to the facility after a predetermined time minus a work preparation time has passed since the operator P reported the completion of work.

The safety staff R logs into the system (201) by using the PDA having the wireless communication function to report the start of work after a predetermined time has passed since the operator P reported the completion of work. Then, the safety staff R checks the temperature and the oxygen level in the incinerator and records the results if necessary. Then, the safety staff R logs into the system (201) by using the PDA having the wireless communication function to report the completion of Work 2

(3) Starting and Completing Work 3

After receiving the report indicating the completion of Work 2 from the safety staff R, the system (201) becomes ready for receiving the report indicating the start of the cleaning work from the cleaning staff Q.

The cleaning staff Q logs into the system (201) by using a PDA having the wireless communication function to report the start of the cleaning work. Upon receiving the report indicating the start of work from the cleaning staff Q, the system (201) issues a token required for the cleaning staff Q to enter the incinerator and stores the token in the PDA of the cleaning staff Q.

When the gates to the incinerator building and the facility as well as the door to the work tool warehouse X (hereinafter referred to as elements associated with an access path) are connected online to the system (201), the system (201) may authorize the cleaning staff Q to have the access rights to the elements associated with the access path except the incinerator after a predetermined time minus the work preparation time has passed since the operator P reported the completion of work. This allows the cleaning staff Q to access the work tool warehouse X and the like, except the incinerator, so that the cleaning staff Q can prepare for the cleaning work before the safety staff R completes the checking work for the temperature and the oxygen level in the incinerator.

When the elements associated with the access path are not connected online to the system (201), the system (201) issues the token required for accessing the elements associated with the access path to the cleaning staff Q upon receiving the report indicating the completion of Work 2 from the safety staff R. The token may include a work order number or an identification number (ID), for example. The token may further include at least one of a security door number, a default expiration date based on the scheduled work completion time, and a token number, for example. The PDA of the cleaning staff Q receives and stores the token in the storage device thereof.

After reporting the start of the incineration cleaning work, the cleaning staff Q logs off from the system (201) and enters the incinerator by using an IC card function embedded in the PDA to perform the incinerator cleaning work. Then, the cleaning staff Q starts cleaning the incinerator.

After completing the incinerator cleaning work, the cleaning staff Q exits the incinerator and returns the helmet, the dust mask, and the safety glove to the work tool warehouse X. Then, the cleaning staff Q logs into the system (201) by using the PDA and reports the completion of Work 3. Upon receiving the report indicating the completion of work from the cleaning staff Q, the system (201) deletes the token associated with Work 3 from the PDA of the cleaning staff Q. No token is required for exiting the incinerator facility.

(4) Starting and Completing Work 4

Upon receiving the report indicating the completion of Work 3, the system (201) allows the operator P to report the start of work for starting the incinerator operation.

The operator P logs into the system (201) by using the PDA to report the start of work for starting the incinerator operation. In this example, the operator P, who is the operator, is registered in the entrance and exit control system to always be allowed to enter the operation control room. Thus, the system (201) does not change the access right of the operator P for entering the operation control room. The operator P executes the work for starting the operation of the incinerator and records the result if necessary. After the incinerator starts operating, the operator P logs into the system (201) by using the PDA having the wireless communication function and reports the completion of Work 4. Upon receiving the report indicating the completion of Work 4 from the operator P, the system (201) deletes the access right for the operator P to perform operation start work.

C. Example of Database Configuration Change

1. Issuing Work Order

A development department creates a work order on the basis of a stipulation in a “database configuration change management process” when required. A manager in the development department approves the created work order based on the process. The approval may be made in accordance with an approval route defined in the database configuration change management process. A desired execution date and time (e.g., Sep. 1, 2010, 1:00) for the configuration change is designated in the work order at the time of creation thereof.

The database configuration change management process is assumed to stipulate works to be performed in the following sequence.

Work 1 Confirming that Operation Using Database are Suspended

Work 2 Acquiring Backup of Database

Work 3 Checking Current Database Configuration Information

Work 4 Changing Database Configuration Information

Work 5 Checking and Recording Database Configuration Information by Different Worker

Work 6 Resuming Operation Using Database

Work 7 Checking that Operation Using Database are Running Normally

2. Identifying Asset

The work order designates a particular database (e.g., an operation DB 3) as a work subject. The system (201) may recognize as an asset the database which is the work subject on the basis of the work order.

3. Identifying Element Associated with Database

An access right to the database is required for the database configuration change. The system (201) reads the work order and recognizes an element associated with an access path to the operation DB 3 based on the work order. Alternatively, the system (201) searches, for example, the asset database (212) or the CMDB (406) for the element associated with the access path to the operation DB 3

The system (201) recognizes the following as the elements associated with the access path to the operation DB 3: a DB server in which the operation DB 3 is operating; a door to a management terminal room 3 provided with a terminal through which the DB server can be accessed; a door to an office area (e.g., the second floor in a building C) including the management terminal rooms; and a front gate for entering a building (e.g., the building C) including the office area.

4. Assigning Worker Entity to Database Configuration Change Work

The database configuration change management process is assumed to stipulate that two workers need to be assigned the work order as a whole including changing database configuration information.

For assigning a worker to configuration change work, several patterns as described below are conceivable, for example.

(1) The system (201) automatically generates a worker assignment plan for the configuration change work in consideration of: a qualification or a skill of a worker; a work schedule of the worker on the day of the configuration change work; whether the worker is scheduled to visit the configuration change work location on the day of the configuration change work; and the like. By using the system (201), a manager of the configuration change work can modify the generated assignment plan and approve the generated assignment plan or the modified assignment plan.

(2) The work manager assigns the configuration change to the worker by using the system (201), e.g., the assignment manager function of Maximo (registered trademark). In this pattern, since the work manager assigns the configuration change to the worker, approval of the assignment plan may be omitted as long as no approval of a higher level manager is required.

(3) An optimum arrangement system that is independent of the system (201) and minimizes the traveling time of the worker automatically generates a worker assignment plan for the configuration change work in consideration of the work locations for other works. By using the system (201), the work manager can modify the generated assignment plan and approve the generated assignment plan or the modified assignment plan. Although the optimum arrangement system is not a subject matter of the present invention, a person skilled in the art can appropriately select the optimum arrangement system usable in the embodiment of the present invention.

(4) The work manager assigns the configuration change work to the worker without using the system (201) and inputs the assignment result to the system (201).

As described in the patterns (1) to (4) above, assigning the worker for the configuration change work secures the worker required for the configuration change work and thus, the scheduled execution date and time for the work order can be determined. Specifically, after a period required for Work 3 using the operation DB 3 is checked, the scheduled execution date and time is determined. Then, the determined scheduled execution date and time is recorded in the work order (i.e., the work order is changed). For example, the scheduled execution date and time may be the same as the target execution date and time and specified to be Sep. 1, 2010, 1:00.

In the present example, it is assumed that workers X and Y are respectively assigned as the work executer and the checker/recorder of DB configuration information.

5. Assigning Access Right to Worker Entity

At the start of the configuration change work, the work executer X logs into the system (201) by bringing the IC card into contact with the card reader (210) of the work terminal (202) to report the start of the configuration change work on the operation DB 3. The system (201) receives the report indicating the start of configuration change work from the work executer X and identifies the access right for the work executer X which is required for the configuration change work on the operation DB 3. The system (201) assigns the identified access right to the work executer X. The system (201) issues a token required for accessing the operation DB 3 upon assigning the access right to the work executer X. The token may include a work order number or an identification number (ID), for example. The token may include at least one of a security door number, a default expiration date obtained based on the scheduled work completion time, and a token number, for example. Generally, multiple tokens are respectively issued for multiple doors. The work terminal (202) operated by the work executer X receives the tokens from the system (201) and records the tokens in the IC card of the work executer X. The system (201) also gives the work executer X the access right to the access management system used to access the DB server.

6. Starting and Completing Configuration Change Work

In the present example, reporting the start and the completion for each of Works 1 to 7 is assumed to be mandatory for auditing. The work executer X checks the work subject and the work steps by using the work terminal (202).

After reporting the start of configuration change work, the work executer X logs off from the system (201). The work executer X brings the IC card into contact with the IC card reader in front of the management terminal room and enters the management terminal room 3. The work executer X accesses the DB server and executes Works 1 to 4. Since the work executer X has the access right to the DB server, the work executer X can log into the DB server through the access management system and change the configuration information of the operation DB 3

The checker/recorder Y reports the start of work to the system (201) and enters the management terminal room 3 as in the same manner as the work executer X does. The checker/recorder Y waits for the work executer X to change the DB configuration information. Upon changing the DB configuration information, the work executer X logs into the system (201) to report the completion of the DB configuration information change. Upon receiving the report indicating the completion of the change, the system (201) determines that a different worker (the checker/recorder Y) can start the work for checking and recording the DB configuration information.

The checker/recorder Y may report the start of work for checking and recording to the system (201) by again logging into the system (201) at or after the reporting by the work executer X. Alternatively, the system (201) may allow the checker/recorder Y to start the work for checking and recording after receiving the report indicating the completion of DB configuration information change from the work executer X. Upon allowing the checker/recorder Y to start the work of checking and recording, the system (201) updates the access right to the access management system given to the checker/recorder Y. Updating the access right allows the checker/recorder Y to log into the DB server to execute Work 5

Upon completing the checking and the recording of the configuration information, the checker/recorder Y reports the completion of Work 5 to the system (201). Upon receiving the report indicating the completion of work from the checker/recorder Y, the system (201) updates the access right to the access management system given to the checker/recorder Y, so that the checker/recorder Y can no longer log into the DB server (provided that the checker/recorder Y is not given the access right to the DB server for other works assigned thereto).

Upon receiving the report indicating the completion of the work from the checker/recorder Y, the system (201) allows the work executer X to resume the operation using the database.

The work executer X reports to the system (201) the completion of confirming that the operation using the database is running normally. Upon receiving the completion report from the work executer X, the system (201) updates the access right to the access management system given to the work executer X so that the work executer X can no longer log into the DB server. Furthermore, the tokens are deleted from the IC card of the work executer X. Thus, the work executer X has no access right to the management terminal room 3 and thus can no longer enter the management terminal room 3. Alternatively, the following setting is possible. Specifically, when the work executer X has logged into the system (201) through the management terminal room 3 and authentication is required for exiting the management terminal room 3, the work executer X is allowed to exit the management terminal room 3 within 10 minutes after reporting the completion.

The work is assigned to the worker entity on the basis of the work order, and the worker entity assigned the work is authorized to have an access right to the asset, the first element, or the second element (hereinafter, also referred to as an access target). Thus, the access right can be given to the worker entity assigned the work only in a time period in which the work needs to be performed. Therefore, the access right to the access target can be more strictly managed.

What is claimed is:

1. A method to manage an access right to at least one asset associated with at least one work order in a digital format, to at least one first element associated with the at least one asset, or to at least one second element associated with an access path to the at least one asset or the first element, the method comprising steps executed by a computer of:
at a scheduled start time for a work order to be executed, or in response to reception of a report indicating a start of work for the work order or a report indicating a completion of work for a preceding work order to the work order, loading the work order into a memory of the computer, and authorizing a worker entity, designated in the loaded work order, to have an access right to the at least one asset, the first element or the second element associated with the work order; and
revoking a granted access right at a scheduled completion time for a work order already started, or in response to reception of a report indicating the completion of work for the work order already started or a report indicating the start of a succeeding work order to the work order already started.

2. The method according to claim 1, further comprising steps executed by the computer of:
generating an access token in the memory in association with the work order, the access token being usable for granting of the access right to the at least one asset, the first element, or the second element; and
transmitting the generated access token to a security device carried by the worker entity authorized to have the access right, the transmitted token being stored in the security device.

3. The method according to claim 2, further comprising a step executed by the computer of deleting or invalidating the access token in the security device at the scheduled completion time for the work order already started, or in response to reception of the report indicating the completion of work for the work order already started or the report indicating the start of work for the succeeding work order to the work order already started.

4. The method according to claim 2, wherein the start or completion of work for the work order is reported by using the security device carried by the worker entity.

5. The method according to claim 2, wherein the worker entity is authenticated by using the security device carried by the worker entity.

6. The method according to claim 1, wherein the access right to the at least one asset, the first element, or the second element is managed online by the computer, the method further comprising steps executed by the computer of:
the at least one asset, the first element, or the second element, receiving a message inquiring whether the worker entity is authorized to access the at least one asset, the first element, or the second element; and
when the worker entity is authorized to access the at least one asset, the first element, or the second element, transmitting a message indicating the granting of the access right of the worker entity, to the at least one asset, the first element, or the second element that transmitted the inquiry message.

7. The method according to claim 6, further comprising a step executed by the computer of transmitting another message indicating the revocation of the granted access right of the worker entity, to the at least one asset, the first element, or the second element that transmitted the inquiry message.

8. The method according to claim 7, further comprising a step executed by the computer of:
deleting the access right from a granting management database that manages whether the worker entity is authorized to access any one of the at least one asset, the first element, and the second element.

9. The method according to claim 1, wherein the access right to the at least one asset, the first element, or the second element is managed online by the computer, the method further comprising a step executed by the computer of:
transmitting a message to the at least one asset, the first element, or the second element indicating the granting of the access right of the worker entity to the at least one asset, the first element, or the second element to which the message indicating the granting is transmitted.

10. The method according to claim 9, further comprising steps executed by the computer of:
transmitting another message indicating the revocation of the granted access right of the worker entity to the at least one asset, the first element, or the second element to which the message indicating the granting is transmitted, at the scheduled completion time for the work order, or in response to reception of the report indicating the completion of work for the work order; and
revoking the access right of the authorized worker entity to the at least one asset, the first element, or the second element to which the message indicating the revocation is transmitted.

11. The method according to claim 1, further comprising a step executed by the computer of:
associating the access right of the at least one asset, the first element, or the second element with the work order.

12. The method according to claim 1, further comprising a step executed by the computer of:
reading, from an access right storing database, the access right of the at least one asset, the first element, or the second element associated with the work order.

13. The method according to claim 1, wherein the step of granting the access right comprises the steps of:
identifying an access right to the at least one asset, the first element, or the second element at the scheduled start time for the work order, or in response to reception of the report indicating the start of work for the work order or the report indicating the completion of work for the preceding work order to the work order; and
assigning the identified access right to the worker entity.

14. The method according to claim 1, further comprising a step executed by the computer of:
assigning the work order to at least one worker entity to execute the work order.

15. The method according to claim 1, further comprising a step executed by the computer of:
reading from a worker entity database at least one worker entity that is assigned to execute the work order.

16. The method according to claim 1, wherein the at least one asset is associated with the work order, the method further comprising a step executed by the computer of:
identifying the first element or the second element associated with the at least one asset specified in the work order by searching an asset database.

17. The method according to claim 1, wherein the computer includes a configuration management system and a configuration management database, the at least one asset is a configuration item, and the work order is issued by a change management process or a release management process.

18. A system that manages an access right to at least one asset associated with at least one work order in a digital format, to at least one first element associated with the at least one asset, or to at least one second element associated with an access path to the at least one asset or the first element, the system comprising:
an authorization unit that, at a scheduled start time for a work order to be executed, or in response to reception of a report indicating a start of work for the work order or a report indicating a completion of work for a preceding work order to the work order, loads the work order into a memory, and authorizes a worker entity, designated in the loaded work order, to have an access right to the at least one asset, the first element or the second element associated with the work order; and
a revocation unit that revokes the access right at a scheduled completion time for a work order already started, or in response to reception of a report indicating the completion of work for the work order already started or a report indicating the start of work for a succeeding work order to the work order already started.

19. The system according to claim 18, further comprising:
an access token generation unit that generates an access token in association with the work order, the access token being used for granting of the access right to the at least one asset, the first element, or the second element; and
a transmitter that transmits the generated access token to a security device carried by the worker entity authorized to have the access right, the transmitted token being stored in the security device.

20. A computer program stored in a storage device for causing a computer to execute the steps in the method according to claim 1.
